(19) United States
(12) Patent Application Publication
(10) Pub. No.: US 2025/0256679 A1
(43) Pub. Date: Aug. 14, 2025

(54) Method and Apparatus for Adapting the Spatial Area for the Automatic Unlocking And/or Locking of a Vehicle

(71) Applicant: Bayerische Motoren Werke Aktiengesellschaft, Muenchen (DE)

(72) Inventors: Thorsten KNOTT, Tuntenhausen (DE); Tomas URBAN, Holzkirchen (DE)

(21) Appl. No.: 19/013,017

(22) Filed: Jan. 8, 2025

(30) Foreign Application Priority Data
Feb. 8, 2024 (DE) 10 2024 103 472.6

(51) Int. Cl. B60R 25/01; B60R 25/24; E05B 81/56; E05B 81/76

(52) U.S. Cl. CPC B60R 25/01; B60R 25/24; E05B 81/77; E05B 81/56

(57) ABSTRACT

An apparatus for controlling an automatic unlocking and/or locking of a vehicle is described, which is automatically effected by a key device located in an environment of the vehicle. The apparatus is configured to detect at least one superfluous unlocking and locking cycle, in which the vehicle is automatically unlocked due to the entry of the key device into a predefined spatial area around the vehicle, and is automatically locked again due to a subsequent removal of the key device, without a door and/or flap of the vehicle having been opened in between. The apparatus is further configured to adapt, in particular to reduce, the spatial area for the automatic unlocking and/or locking of the vehicle in response to the detection.

### CROSS REFERENCE TO RELATED APPLICATION

This application claims priority under 35 U.S.C. § 119 from German Patent Application No. DE 10 2024 103 472.6, filed Feb. 8, 2024, the entire disclosure of which is herein expressly incorporated by reference.

### BACKGROUND AND SUMMARY

The invention relates to a method and a corresponding apparatus for automatically unlocking and/or locking a (motor) vehicle by means of a key device comprising a digital key.

A vehicle can have one or more functions that can be controlled remotely by a user of the vehicle using an electronic device, such as a smartphone. An exemplary vehicle function is the opening or unlocking and/or closing or locking of a door or flap of the vehicle. The remote control of one or more vehicle functions is typically carried out via a wireless communication link, in particular via a BLE (Bluetooth Low Energy) communication link, between the vehicle and the electronic (key) device.

Unlocking and/or locking (of one or more doors and/or flaps) of the vehicle can be effected automatically if it is detected on the basis of the communication link that the key device is less than or greater than a specific distance from the vehicle. The automatic unlocking and/or locking of the vehicle can be perceived as uncomfortable by a user of the vehicle in certain situations. Furthermore, the automatic unlocking and/or locking of the vehicle leads to energy consumption.

The present document deals with the technical object of increasing the comfort and/or energy efficiency of the automatic unlocking and/or locking of a vehicle by means of a key device in a reliable manner.

The object is achieved by each of the independent claims. Advantageous embodiments are described, inter alia, in the dependent claims. It should be noted that additional features of a claim dependent on an independent claim can form a separate invention which is independent of the combination of all features of the independent claim, without the features of the independent claim or only in combination with a sub-set of the features of the independent claim and the separate invention can be made the subject of an independent claim, a divisional application or a subsequent application. This applies in the same way to technical teachings described in the description, which can form an invention independent of the features of the independent claims.

According to one aspect, an apparatus for controlling the automatic unlocking and/or locking (in particular the automatic unlocking) of a (motor) vehicle (in particular of one or more doors and/or flaps of the vehicle) is described, wherein the automatic unlocking and/or locking is effected automatically by a key device located in the environment of the vehicle. The key device can have a digital key for authenticating the key device at the vehicle. The digital key can be designed in accordance with the Car Connectivity Consortium, CCC, key standard, in particular in accordance with CCC Release 3. The key device can be a mobile and/or portable user device (such as a smart device and/or a smartphone). The apparatus can be part of the key device and/or of the vehicle.

The apparatus can be configured to provide a communication link (in particular a Bluetooth, such as a Bluetooth Low Energy (BLE) and/or an ultrawideband (UWB) communication link) between the vehicle and the key device. The automatic unlocking and/or locking of the vehicle can be effected via the (BLE and/or UWB) communication link.

The apparatus can be configured to enable an automatic unlocking and/or locking of the vehicle by sending (via the (BLE) communication link) a request message (in particular a range intent message) from the key device to the vehicle, wherein the request message is aimed at requesting the vehicle to determine position information in relation to the (respectively prevailing) position of the key device. The position information can then be determined via the ultrawideband (UWB) communication link between the vehicle and the key device. The position information can be determined repeatedly (in response to the request message), in particular periodically, in order to determine the respectively prevailing position of the key device relative to the vehicle. The position information can indicate the respective distance of the prevailing position of the key device from the vehicle. Furthermore, if necessary, the position information can indicate the azimuth angle of the prevailing position of the key device.

The vehicle can use the determined position information to unlock or lock the vehicle. For example, it can be effected (by the vehicle) that the vehicle automatically unlocks when the determined position information indicates that the distance of the key device from the vehicle is equal to or less than an unlocking threshold value. On the other hand, it can be effected (by the vehicle) that the vehicle automatically locks if the determined position information indicates that the distance of the key device from the vehicle is equal to or greater than a locking threshold value. The locking threshold value can be equal to or greater than the unlocking threshold value.

In general, a spatial area can be defined for the automatic unlocking and/or locking of the vehicle. The spatial area can be defined by at least one distance threshold value (in particular the unlocking threshold value and/or the locking threshold value) (for example so that an essentially circular area results). The automatic unlocking can be effected when, in particular as soon as, the key device enters the predefined spatial area. On the other hand, automatic locking can be effected when the key device leaves the spatial area again.

The apparatus is configured to detect at least one superfluous unlocking and locking cycle in which the vehicle is automatically unlocked due to the entry of the key device into the predefined spatial area around the vehicle, and is automatically locked again due to a subsequent removal of the key device (from the spatial area), without (any) door and/or flap of the vehicle having been opened in between (i.e., between the automatic unlocking and the subsequent automatic locking). If necessary, a specific number (e.g., 2 or more, or 5 or more) of (directly consecutive) superfluous unlocking and locking cycles can be detected.

The apparatus is further configured, in response to the detection (of the one or more, in particular the predetermined number, of superfluous unlocking and locking cycles), to adapt, in particular to reduce, the spatial area for the automatic unlocking and/or locking of the vehicle. As already explained above, the spatial area around the vehicle can be defined by at least one distance threshold value, in particular by the unlocking threshold value for the automatic unlocking of the vehicle and/or by the locking threshold value for the automatic locking of the vehicle. The distance threshold value can then be adapted, in particular reduced, in response to the detection.

One or more (in particular a specific number of) superfluous unlocking and locking cycles can thus be detected, and the spatial area for the automatic unlocking and/or locking of the vehicle can then be adapted, in particular reduced. In this way, the comfort and energy efficiency of the automatic unlocking and/or locking function can be increased.

The apparatus can be configured to detect a sequence of consecutive superfluous unlocking and locking cycles. The spatial area, in particular the distance threshold value, for the automatic unlocking and/or locking of the vehicle can then be further reduced step by step (e.g., with a predefined step width) with each detected superfluous unlocking and locking cycle. In this way, the comfort and energy efficiency of the automatic unlocking and/or locking function can be further increased.

The apparatus can be configured to issue a notification to the user of the key device and/or of the vehicle in response to the detection of a superfluous unlocking and locking cycle. The notification can be aimed at causing the user to define a deactivation data record with one or more deactivation conditions for the (selective) deactivation of the automatic unlocking and/or locking of the vehicle.

One or more (in particular a specific number of) superfluous unlocking and locking cycles can thus be detected, and a deactivation data record for the (selective) deactivation of the automatic unlocking and/or locking of the vehicle can then be set (if necessary in each case) by outputting a notification. In this way, the comfort and energy efficiency of the automatic unlocking and/or locking function can be increased to a particularly high degree.

The apparatus can be configured in response to the detection of a superfluous unlocking and locking cycle, in particular in response to the detection of a predefined maximum number of (directly) consecutive superfluous unlocking and locking cycles:
to deactivate the automatic unlocking of the vehicle due to the entry of the key device into the (possibly adapted) spatial area around the vehicle; and/or
only to effect the unlocking of the vehicle when a door handle of the vehicle is touched and/or when the key device is held against a Near Field Communication (NFC) reader of the vehicle.

It is therefore possible to (temporarily) deactivate the remote-controlled automatic unlocking and/or locking of the vehicle if a specific maximum number of superfluous unlocking and locking cycles has been detected.

In this context, the apparatus can be configured to check whether or not the user has defined a deactivation data record following the output of one of the above-mentioned notifications. The above-mentioned deactivation of the remote-controlled automatic unlocking and/or locking of the vehicle can only be effected if it is determined that the user has not defined a deactivation data record, in particular also not after the maximum number of consecutive superfluous unlocking and locking cycles (and possibly the corresponding maximum number of issued notifications).

The user can thus be enabled to define a deactivation data record via which the automatic locking and/or unlocking of the vehicle can be deactivated depending on the conditions, in order to further increase the comfort and energy efficiency of the automatic locking and/or unlocking of the vehicle.

The apparatus can be configured to identify a spatial sub-area of the spatial area for the automatic unlocking and/or locking of the vehicle in which the key device was located during the superfluous unlocking and locking cycle. The sub-area can be identified on the basis of the above-mentioned position information. For example, based on the position information, it is possible to determine a plurality of different points (i.e. positions) within the spatial area at which the key device was located during the superfluous unlocking and locking cycle. Based on the plurality of different points, the spatial sub-area of the spatial area for the automatic unlocking and/or locking of the vehicle can then be determined in a precise manner.

For example, a sub-area running in a ring-shaped manner around the vehicle can be identified. Alternatively, the sub-area can be identified as an enclosure, in particular as a convex enclosure, of the multitude of different points.

The apparatus can be configured to determine an adapted spatial area for the (subsequent) automatic unlocking and/or locking of the vehicle, from which the identified sub-area has been excluded. In particular, the (original) spatial area can be reduced (precisely) by the identified sub-area in order to determine the adapted spatial area for the subsequent operation of the automatic unlocking and/or locking of the vehicle.

It is thus possible to precisely exclude from the spatial area for the automatic unlocking and/or locking of the vehicle precisely the sub-area in which the key device was located during the one or more superfluous unlocking and locking cycles. In this way, the comfort and energy efficiency of the automatic unlocking and/or locking of the vehicle can be increased to a particularly high degree.

The apparatus can be configured to determine the distance, in particular the minimum distance, up to which the key device has approached the vehicle during the superfluous unlocking and locking cycle. The (possibly ring-shaped) spatial sub-area and/or the (possibly circular) adapted spatial area can then be determined in a particularly precise and efficient manner on the basis of the distance, in particular the minimum distance.

The apparatus can be configured to detect subsequently to the at least one superfluous unlocking and locking cycle that a door and/or flap of the vehicle has been opened. In response, the spatial area, in particular the distance threshold value, for the automatic unlocking and/or locking of the vehicle can be reset to the (original) default value. In this way, the comfort of automatic locking and/or unlocking of the vehicle can be further increased.

According to a further aspect, a (road) motor vehicle (in particular a passenger car or a truck or a bus or a motorcycle) is described which comprises the apparatus described in this document.

According to a further aspect, a (mobile and/or portable) user device (e.g., a smart device and/or a smartphone) is described which comprises the apparatus described in this document.

According to a further aspect, a method is described for controlling an automatic unlocking and/or locking of a (motor) vehicle, which is automatically effected by a key device located in an environment of the vehicle. The method comprises detecting at least one superfluous unlocking and locking cycle in which the vehicle is automatically unlocked due to the entry of the key device into a predefined spatial area around the vehicle, and is automatically locked again due to a subsequent removal of the key device, without a door and/or flap of the vehicle having been opened in between. Furthermore, the method comprises adapting, in particular reducing, the spatial area for the automatic unlocking and/or locking of the vehicle in response to the detection.

According to a further aspect, a software (SW) program is described. The SW program can be configured to be executed on a processor, and thereby to perform the method described in this document.

According to a further aspect, a storage medium is described. The storage medium can comprise a SW program configured to be executed on a processor and thereby to perform the method described in this document.

It should be noted that the methods, apparatuses and systems described in this document can be used alone or also in combination with other methods, apparatuses and systems described in this document. Furthermore, any aspects of the methods, apparatuses and systems described in this document can be combined with each other in a variety of ways. In particular, the features of the claims can be combined in a variety of ways. Furthermore, features listed in brackets are to be understood as optional features.

Furthermore, the invention is described in more detail below with reference to exemplary embodiments. In the drawing:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows an exemplary digital access system of a vehicle;

FIG. 1b shows an exemplary usage situation for a digital access system;

FIG. 2 shows exemplary messages for determining position information in relation to the position of a key device;

FIG. 3 shows an exemplary deactivation data record with exemplary deactivation conditions;

FIG. 4 shows a flowchart of an exemplary method for adapting the spatial area for the automatic unlocking and/or locking of a vehicle; and

FIGS. 5a and 5b show different spatial areas for the automatic unlocking and/or locking of a vehicle.

### DETAILED DESCRIPTION OF THE DRAWINGS

As stated at the beginning, the present document is concerned with increasing comfort and/or energy efficiency during the automatic unlocking and/or locking of a vehicle by means of a digital key device. In this context, Fig. la shows an exemplary (access) system 150 comprising at least one vehicle 100 and a digital key device 110. The digital key device 110 is typically a portable electronic device, such as a smartphone or a tablet PC, wherein a digital key 111 is stored on the portable electronic device. The digital key 111 can be stored in a protected memory area, in particular in a so-called “secure element”, of the portable electronic device (such as the user device).

The digital key device 110 is configured to communicate with a communication unit 102 of the vehicle 100 via one or more different wireless communication links 112. The different communication links 112 can be used for different purposes. In particular, a Bluetooth Low Energy (BLE) communication link 112 can be used:
to determine the distance and/or relative position between the digital key device 110 and the vehicle 100 (in particular based on the signal strength, in particular the RSSI (Received Signal Strength Indicator), of the radio signals exchanged between the vehicle 100 and the device 110; and/or using BLE channel sounding (mode 2/phase-based measurements)); and/or
to exchange data between the digital key device 110 and the vehicle 100 (e.g., a control command for controlling a vehicle function 103, such as unlocking a door and/or opening or closing a window and/or activating or deactivating a heating function and/or activating or deactivating the drive motor of the vehicle 100).

Alternatively or additionally, an ultrawideband (UWB) communication link 112 can be used to determine the position of the device 110 relative to the vehicle 100 with a relatively high degree of accuracy. Determining the position of the device 110 using the UWB communication link 112 can be referred to as UWB ranging.

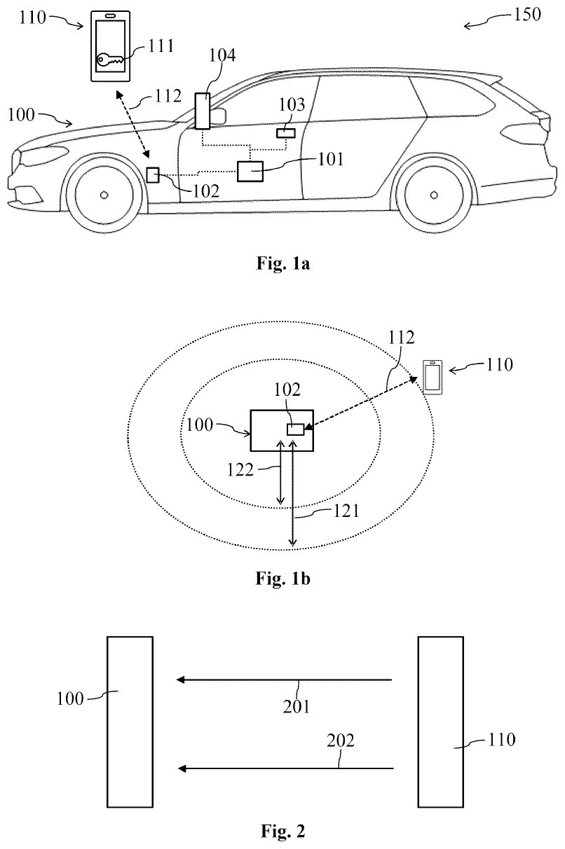

A (control) apparatus 101 of the vehicle 100 can be designed to control at least one vehicle function 103 of the vehicle 100 as a function of the communication between the device 110 and the vehicle 100, as shown by way of example in FIG. 1b. In this context, the digital key 111 of the device 110 can be verified, in particular authenticated. Furthermore, after successful authentication, one or more vehicle functions 103 can be controlled, in particular as a function of.
the distance between the device 110 and the vehicle 100;
the position of the device 110 relative to the vehicle 100; and/or
a control command sent from the device 110 to the vehicle 100 via a communication link 112.

In an exemplary system 150, a BLE communication link 112 can be established between the device 110 and the vehicle 100 once the distance between the device 110 and the vehicle 100 is equal to or less than a first distance threshold value 121. This allows the user to perform remote control of one or more vehicle functions 103 using the device 110. Typically, the vehicle 100 repeatedly indicates, for example, at a particular frequency, the availability of a BLE communication link 112. At distances greater than the first distance threshold value 121, the device 110 (which can also be referred to as a “user equipment” (UE)) receives the indication message from the vehicle 100 and the BLE communication link 112 can then be established between the device 110 and the vehicle 100. The first distance threshold value 121 can depend on the communication capabilities of the device 110, the environment of the vehicle 100 and/or the device 110, and/or the position of the device 110 relative to the vehicle 100.

Further, a UWB communication link 112 can be established between the device 110 and the vehicle 100 once the distance between the device 110 and the vehicle 100 is equal to or less than a second distance threshold value 122 (which can be less than the first distance threshold value 121 and/or which can depend on the communication capabilities of the device 110). Based on the UWB communication link 112, the location of the device 110 can be determined with a relatively high degree of accuracy.

An exemplary vehicle function 103 that can be provided via the one or more communication links 112 is the automatic unlocking (of one or more doors and/or flaps) of the vehicle 100 once the key device 110 has reached or fallen below a specific unlocking threshold value, and/or the automatic locking (of one or more doors and/or flaps) of the vehicle 100 once the key device 110 has reached or exceeded a specific locking threshold value.

For example, the user can approach the vehicle 100 with the key device 110, and as soon as it is detected that the key device 110 has reached or fallen below the unlocking threshold value, one or more vehicle doors and/or flaps can be unlocked automatically (without requiring contact with a touch sensor of the vehicle 100). The user can then open a vehicle door or flap directly (without delay). The automatic unlocking takes place immediately when the unlocking threshold value is reached or fallen below and not only when the user touches the handle of a vehicle door or flap.

FIG. 2 shows exemplary messages 201, 202 that are sent from the key device 110 to the vehicle 100 for an automatic unlocking (via an already existing BLE and/or UWB communication link 112). In particular, a request message 201 (in particular a so-called range-intent message) can be sent from the key device 110 to the vehicle 100 (typically via the BLE communication link 112), requesting the vehicle 100 to determine position information in relation to the position of the key device 110 relative to the vehicle 100. In particular, the position information can include the distance of the key device 110 from the vehicle 100.

A positioning message 202 can then be sent (repeatedly if necessary) from the key device 110 to the vehicle 100. The positioning message 202 can be sent via the UWB communication link 112. The positioning message 202 (for example, the signal strength and/or the run-time of the positioning message 202) can be used by the vehicle 100 to determine the position information in relation to the position of the key device 110 relative to the vehicle 100.

When the vehicle 100 detects (based on the (possibly repeatedly) determined position information) that the key device 110 reaches or falls below the unlocking threshold value, the automatic unlocking (of the one or more doors and/or flaps) of the vehicle 100 can be effected.

Accordingly, an automatic locking (of the one or more doors and/or flaps) of the vehicle 100 can be effected (when the key device 110 reaches or exceeds the locking threshold value).

It can happen that the user of the vehicle 100 is located in the environment of the vehicle 100 with his key device 110 (possibly multiple times), without the user intending to unlock the vehicle 100. For example, the user can walk past the vehicle 100 with the key device 110 (possibly multiple times), which in each case leads to unlocking and subsequent locking of the vehicle 100, which in turn can be perceived as uncomfortable by the user of the vehicle 100 (for example due to the noises and/or visual signals generated and/or produced in the process) and which leads to increased energy consumption (of the vehicle 100 and the key device 110).

As already explained above, the key device 110 is typically a mobile user device (such as a smartphone) that has, for example, a touch-sensitive screen. A software application (a so-called app) can be provided on the key device 110, which can be used to effect remote control of one or more vehicle functions 103. For example, a user can be enabled to define and send a control command to control a vehicle function 103 via a (graphical) user interface.

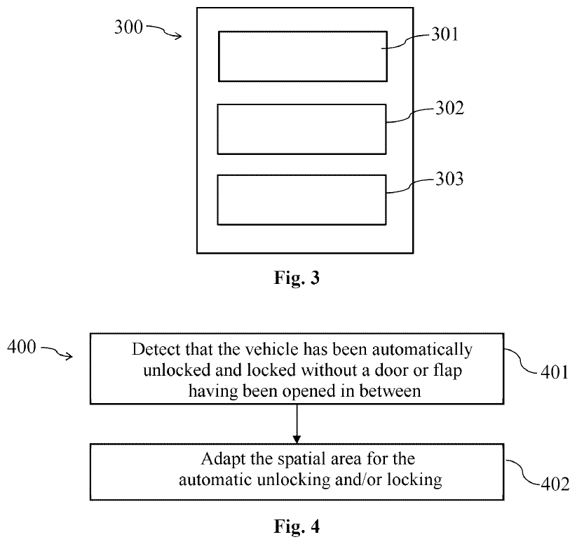

The user of the vehicle 100 can be enabled to define, via the user interface on the key device 110, at least one deactivation data record 300 comprising one or more deactivation conditions 301, 302, 303 for selectively deactivating the automatic unlocking and/or locking of the vehicle 100 (see FIG. 3). The one or more deactivation conditions 301, 302, 303 can include, for example,
a time deactivation condition 301, which specifies for example
   a period of time (e.g., starting from a reference point in time) for which the automatic unlocking and/or locking is deactivated; the reference time can be, for example, the point in time at which the time deactivation condition 301 is set; and
   a daily time interval (starting with a start time and ending with an end time) in which automatic unlocking and/or locking is deactivated;
   a calendar deactivation condition 302 that specifies, for example, a date or day of the week that must be present for the automatic unlocking and/or locking to be deactivated; and/or
   a local deactivation condition 303 that specifies, for example, a local area in which the vehicle 100 and/or the key device 110 must be located in order for the automatic unlocking and/or locking to be deactivated.

The user can be enabled to define multiple deactivation data records 300, for example for different days of the week (e.g., working days or weekends) and/or for different local areas (for example place of residence or workplace).

The key device 300 can be configured to analyze the one or more deactivation data records 300 defined by the user during an approach process to the vehicle 100 (generally during a movement process in the environment of the vehicle 100), in order to check whether the automatic unlocking and/or locking is to be deactivated or is to remain activated during the approach process. In particular, it can be checked whether all deactivation conditions 301, 302, 303 of at least one deactivation data record 300 are fulfilled during the approach process. If this is the case, the automatic unlocking and/or locking can be deactivated during the approach process. On the other hand, if a deactivation data record 300 is not defined for which all deactivation conditions 301, 302, 303 are fulfilled, the automatic unlocking and/or locking can be kept active.

The deactivation of the automatic unlocking and/or locking during an approach process can be effected in an efficient and reliable manner by the fact that no request message 201 (in particular no “ranging intent” message) is sent from the key device 110 to the vehicle 100. As a result, the vehicle 100 does not determine any position information in relation to the position of the key device 110, so that position-dependent unlocking or locking cannot be effected.

It can be detected (for example, by the device 101 of the vehicle 100 and/or by the key device 110) that an automatic unlocking and a subsequent automatic locking of the vehicle 100 has been effected (due to the proximity of the key device 110 to the vehicle 100) without (any) door or flap of the vehicle 100 having been opened between the automatic unlocking and the subsequent automatic locking. Such an unlocking and locking cycle can be referred to as a superfluous unlocking and locking cycle, since the unlocking was superfluous due to the non-opening of (any) door or flap of the vehicle 100.

An action can be effected after a specific number (e.g., 1 or more, or 2 or more, or 5 or more) of detected superfluous unlocking and locking cycles, the action being aimed at temporarily and/or selectively and/or area-wise deactivating the automatic unlocking and/or locking. In particular, as an action, a notification can be issued to the user of the key device 110 (via the user interface of the key device 110) informing the user that a deactivation data record 300 can be defined to selectively deactivate the automatic unlocking and/or locking.

If necessary, one or more general conditions can be determined that were present during the individual detected superfluous unlocking and locking cycles. Examples of general conditions are
the time of day;
the day of the week;
the date; and/or
the local area.

Based on the one or more general conditions that were present for the individual detected superfluous unlocking and locking cycles, a suggestion for a deactivation data record 300 with one or more deactivation conditions 301, 302, 303 can be automatically determined, if necessary, which can be suggested to the user (via the user interface). In this way, the comfort for the user can be further increased.

Alternatively or additionally, after a specific number (e.g., 1 or more, or 2 or more, or 5 or more) of detected superfluous unlocking and locking cycles, the range for the automatic unlocking and/or locking of the vehicle 100 can be adapted, in particular reduced. In particular, the unlocking threshold value and/or the locking threshold value can be adapted, in particular reduced. In this way, the frequency of superfluous unlocking and locking cycles can be reduced.

For example, the range, in particular the unlocking threshold value and/or the locking threshold value, can be reduced step by step (e.g., by a specific absolute or percentage value in each case) as the number of detected superfluous unlocking and locking cycles increases. In this way, the range for the automatic unlocking and/or locking of the vehicle 100 can be gradually adapted to the respective prevailing usage situation.

Alternatively or additionally, it can be effected (e.g., by the apparatus 101 of the vehicle 100 and/or by the key device 110), that the remote-controlled automatic unlocking and/or locking of the vehicle 100 is completely deactivated, for example
if a specific maximum number of (directly consecutive) superfluous unlocking and locking cycles has been reached or exceeded; and/or
if the user has not responded (possibly multiple times) to the instruction of above-mentioned notification (to create a deactivation data record).

As a result, in order to unlock and/or lock the vehicle 100, it can be necessary for the user to hold the key device 110 directly against the door and/or flap that is to be unlocked and/or locked. In this case, communication between the key device 110 and the vehicle 100 can be effected via NFC (Near Field Communication), for example.

If (for example by the apparatus 101 of the vehicle 100 and/or by the key device 110) an unlocking of the vehicle 100 with a subsequent opening of a door and/or flap of the vehicle 100 has been detected, a reset of the automatic unlocking and/or locking of the vehicle 100 can be effected. In particular,
the distance-dependent remote control can be reactivated (if it was previously deactivated); and/or.
the range (in particular the unlocking threshold value and/or the locking threshold value) can be set to a default value again.

It is thus possible to automatically limit and/or reduce the range of the proximity function when one or more superfluous unlocking and locking cycles have been detected. For this purpose, one or more threshold values (in particular the unlocking threshold value and/or the locking threshold value) can be reduced, in particular one or more threshold values for waking up one or more control devices of the vehicle 100 depending on the distance to the key device 110. A reduction of the activation and/or wake-up distance can thus be effected.

Furthermore, if the user repeatedly fails to respond to a notification issued relating to a detected superfluous unlocking and locking cycle, the proximity function can be automatically degraded so that the vehicle 100 can only be unlocked using a door handle.

These actions can extend the operating run-time of the function by making careful use of the battery capacity of the vehicle 100.

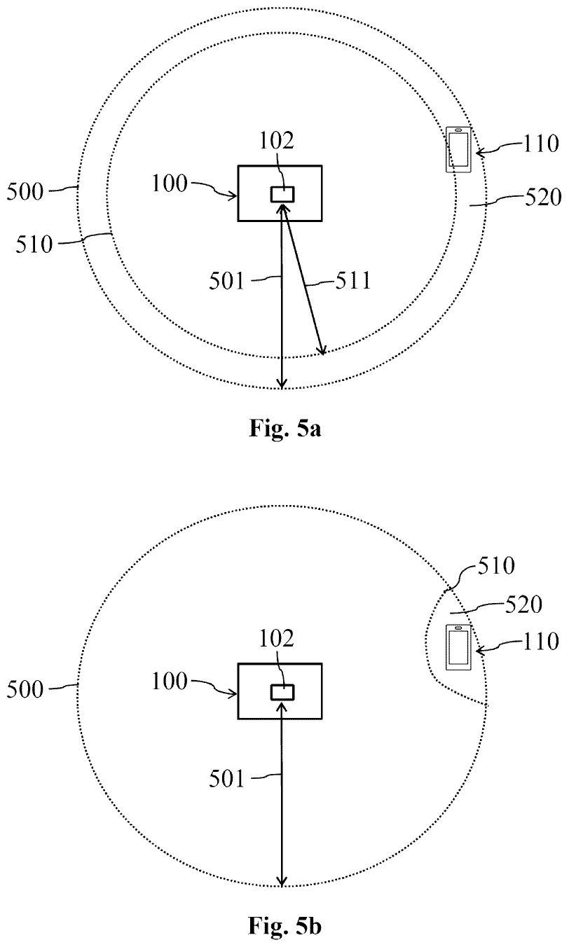

FIG. 5a shows an exemplary spatial area 500 around the vehicle 100 for an automatic unlocking and/or locking of the vehicle 100. The spatial area 500 can be defined by a distance threshold value 501 (in particular by the unlocking threshold value and/or the locking threshold value). The spatial area 500 can define the range of automatic unlocking and/or locking of the vehicle 100.

If it is detected that the key device 110 enters the spatial area 500, an automatic unlocking can be effected. Furthermore, when the key device 110 exits the spatial area 500, an automatic locking can be effected. If a door and/or flap of the vehicle 100 has not been opened between unlocking and locking, this can be detected as a superfluous unlocking and locking cycle.

After one or after a specific number of consecutive superfluous unlocking and locking cycles, an adapted spatial area 510 can be determined, which is defined, for example, by an adapted, in particular by a reduced, distance threshold value 511.

The apparatus (of the vehicle 100 and/or the key device 110) can be configured to identify a spatial sub-area 520 of the original (non-adapted) spatial area 500 in which the key device 110 was located during the one or more superfluous unlocking and locking cycles. This can be determined based on positional information in relation to the position of the key device 110 relative to the vehicle 100, which is determined based on the (UWB) communication link 112 between the vehicle 100 and the key device 110.

The adapted spatial area 510 can be determined in a particularly precise manner based on the identified spatial sub-area 520. In particular, the identified sub-area 520 can be excluded from the original area 500 in order to determine the adapted area 510.

In the example illustrated in FIG. 5a, a ring-shaped sub-area 520 of the original area 500 is identified such that the adapted area 510 is circular and defined by an adapted distance threshold value 511. For example, a minimum distance up to which the key device 110 has approached the vehicle 100 during the one or more superfluous unlocking and locking cycles can be determined. The adapted distance threshold value 511 can then be determined based on the minimum distance, in particular as the determined minimum distance.

In the example illustrated in FIG. 5b, a sub-area 520 of the original area 510 that surrounds the key device 110 is identified. The sub-area 520 can be defined, for example, by a polygon and/or by a convex enclosure around the key device 110. Based on the position information, a plurality of positions of the key device 110 within the spatial area 500 can be determined during the one or more superfluous unlocking and locking cycles. The sub-area 520 can be determined as a (convex) enclosure around the plurality of positions of the key device 110.

The exclusion of such a sub-area 520 results in an adapted spatial area 510, which is no longer circular and/or which can no longer be defined by a distance threshold value 501. On the other hand, the adapted area 510 can thus be adapted in a precise manner to the actual movement of the key device 110 without restricting the area 510 for the automatic unlocking and locking of the vehicle 100 too much.

If an opening of a door and/or flap is detected, the spatial area 500 for the automatic unlocking and locking of the vehicle 100 can be reset to the original default value.

FIG. 4 shows a flowchart of an exemplary (possibly computer-implemented) method 400 for controlling the automatic unlocking and/or locking of a (motor) vehicle 100, which is automatically effected by a key device 110 located in the environment of the vehicle 100. The method 400 can be executed by the key device 110 and/or by the vehicle 100.

The method 400 comprises the detection 401 at least of one superfluous unlocking and locking cycle, wherein the vehicle 100 is automatically unlocked due to an approach of the key device 110 (e.g., due to an entry of the key device 110 into a predefined spatial area 500 for the automatic unlocking and/or locking of the vehicle 100), and is automatically locked again due to a subsequent removal of the key device 110 (e.g., a removal out of the predefined spatial area 500), without (any) door and/or flap of the vehicle 100 having been opened in between. If necessary, a specific number of such superfluous unlocking and locking cycles (during which a door and/or flap of the vehicle 100 has not been opened) can be detected (e.g., 2 or more, or 5 or more, or 10 or more).

The method 400 further comprises, in response to the detection 401 (of at least one or a predetermined number of superfluous unlocking and locking cycles), effecting 402 at least one action aimed at least at temporarily and/or selectively and/or area-wise deactivating the automatic unlocking and/or locking of the vehicle 100. In particular, in response to the detection 401, it is possible to effect the adaptation 402, in particular the reduction, of the spatial area 500, 510 for the automatic unlocking and/or locking of the vehicle 100. The adaptation 402 of the spatial area 500, 510 for the automatic unlocking and/or locking of the vehicle 100 thereby represents an action which is aimed at deactivating the automatic unlocking and/or locking of the vehicle 100 at least in specific areas.

Alternatively or additionally, the output of a message to the user of the vehicle 100 and/or the key device 110 can be effected as an action, which draws the attention of the user to the possibility of defining a deactivation data record 300 in order to avoid superfluous unlocking and locking cycles. If necessary, a suggestion for one or more deactivation conditions 301, 302, 303 for the deactivation data record 300 can be made on the basis of the analysis of one or more general conditions under which the one or more superfluous unlocking and locking cycles have occurred.

By detecting one or more superfluous unlocking and locking cycles and by deactivating the automatic unlocking and/or locking in specific areas (in particular by reducing the range of the automatic unlocking and/or locking), the comfort of a vehicle user and the energy efficiency of the automatic unlocking and/or locking function of the vehicle 100 can be increased in a particularly reliable manner.

The present invention is not limited to the exemplary embodiments shown. In particular, it should be noted that the description and the figures are only intended to illustrate the principle of the proposed methods, apparatuses and systems by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for controlling an automatic unlocking and/or locking of a vehicle, which is automatically effected by a key device located in an environment of the vehicle, wherein the apparatus is configured to:
detect at least one superfluous unlocking and locking cycle in which the vehicle is automatically unlocked due to an entry of the key device into a predefined spatial area around the vehicle, and is automatically locked again due to a subsequent removal of the key device from the predefined spatial area without a door and/or flap of the vehicle having been opened in between; and
reduce the predefined spatial area for the automatic unlocking and/or locking of the vehicle in response to the detection.

2. The apparatus according to claim 1, wherein
the predefined spatial area around the vehicle is defined by at least one distance threshold value, including an unlocking threshold value for the automatic unlocking of the vehicle, and/or by a locking threshold value for the automatic locking of the vehicle; and
the apparatus is configured to reduce the distance threshold value in response to the detection.

3. The apparatus according to claim 1, wherein the apparatus is configured to:
detect a predefined number of consecutive superfluous unlocking and locking cycles; and
in response to detection of the predefined number of consecutive superfluous unlocking and locking cycles, to reduce the spatial area, including a distance threshold, for the automatic unlocking and/or locking of the vehicle.

4. The apparatus according to claim 2, wherein the apparatus is configured to:
detect a predefined number of consecutive superfluous unlocking and locking cycles; and
in response to detection of the predefined number of consecutive superfluous unlocking and locking cycles, to reduce the spatial area, including a distance threshold, for the automatic unlocking and/or locking of the vehicle.

5. The apparatus according to claim 2, wherein the apparatus is configured to:
detect a sequence of consecutive superfluous unlocking and locking cycles; and
further reduce the distance threshold value for the automatic unlocking and/or locking of the vehicle with each detected superfluous unlocking and locking cycle.

6. The apparatus according to claim 4, wherein the apparatus is configured to:
detect a sequence of consecutive superfluous unlocking and locking cycles; and
further reduce the distance threshold value for the automatic unlocking and/or locking of the vehicle with each detected superfluous unlocking and locking cycle.

7. The apparatus according to claim 1, wherein the apparatus is configured, in response to detecting a predefined maximum number of consecutive superfluous unlocking and locking cycles,
to deactivate the automatic unlocking of the vehicle due to an entry of the key device into the predefined spatial area around the vehicle; and/or
to effect the unlocking of the vehicle only when a door handle of the vehicle is touched and/or when the key device is held against a Near Field Communication reader of the vehicle.

8. The apparatus according to claim 2, wherein the apparatus is configured, in response to detecting a predefined maximum number of consecutive superfluous unlocking and locking cycles,
to deactivate the automatic unlocking of the vehicle due to an entry of the key device into the predefined spatial area around the vehicle; and/or
to effect the unlocking of the vehicle only when a door handle of the vehicle is touched and/or when the key device is held against a Near Field Communication (NFC) reader of the vehicle.

9. The apparatus according to claim 1, wherein
the apparatus is configured to output a notification to a user of the key device and/or of the vehicle in response to the detection of a superfluous unlocking and locking cycle; and
the notification is aimed at causing the user to define a deactivation data record comprising one or more deactivation conditions for the deactivation of the automatic unlocking and/or locking of the vehicle.

10. The apparatus according to claim 2, wherein
the apparatus is configured to output a notification to a user of the key device and/or of the vehicle in response to the detection of a superfluous unlocking and locking cycle; and
the notification is aimed at causing the user to define a deactivation data record comprising one or more deactivation conditions for the deactivation of the automatic unlocking and/or locking of the vehicle.

11. The apparatus according to claim 7, wherein the apparatus is configured:
to verify whether the user has defined a deactivation data record subsequently to the output of the notification; and
if it is determined that the user has not defined the deactivation data record after the maximum number of consecutive superfluous unlocking and locking cycles and a corresponding maximum number of issued notifications,
to deactivate the automatic unlocking of the vehicle due to an entry of the key device into the predefined spatial area around the vehicle; and/or
to effect the unlocking of the vehicle only when a door handle of the vehicle is touched and/or when the key device is held against the NFC reader of the vehicle.

12. The apparatus according to claim 1, wherein the apparatus is configured to:
identify a spatial sub-area of the predefined spatial area for the automatic unlocking and/or locking of the vehicle in which the key device was located during the superfluous unlocking and locking cycle; and
determine an adapted spatial area for the automatic unlocking and/or locking of the vehicle, from which the identified sub-area has been excluded.

13. The apparatus according to claim 12, wherein the apparatus is configured to:
determine a minimum distance up to which the key device has approached the vehicle during the superfluous unlocking and locking cycle; and
determine the spatial sub-area and/or the adapted spatial area based on the minimum distance.

14. The apparatus according to claim 12, wherein the apparatus is configured to:
identify a sub-area running in a ring-shaped manner around the motor vehicle; and/or
determine a plurality of different points within the spatial area at which the key device was located during the superfluous unlocking and locking cycle, and to identify the sub-area as a convex enclosure of the plurality of different points.

15. The apparatus according to claim 13, wherein the apparatus is configured to:
identify a sub-area running in a ring-shaped manner around the motor vehicle; and/or
determine a plurality of different points within the spatial area at which the key device was located during the superfluous unlocking and locking cycle, and to identify the sub-area as a convex enclosure of the plurality of different points.

16. The apparatus according to claim 1, wherein the apparatus is configured:
subsequently to the at least one superfluous unlocking and locking cycle, to detect that a door and/or flap of the vehicle has been opened; and
in response to detecting that the door and/or the flap of the vehicle has been opened, to reset a distance threshold value for the automatic unlocking and/or locking of the vehicle to a default value.

17. A method for controlling an automatic unlocking and/or locking of a vehicle automatically effected by a key device located in an environment of the vehicle, the method comprising:
detecting at least one superfluous unlocking and locking cycle in which the vehicle is automatically unlocked due to entry of the key device into a predefined spatial area around the vehicle, and is automatically locked again due to a subsequent removal of the key device without a door and/or flap of the vehicle having been opened in between; and
reducing the predefined spatial area for the automatic unlocking and/or locking of the vehicle in response to the detection.
